(19) United States
(12) Patent Application Publication
(10) Pub. No.: US 2005/0124755 A1
(43) Pub. Date: Jun. 9, 2005

(54) Polyvinyl alcohol and optical brightener concentrate

(76) Inventors: Craig E. Mitchell, Highland Village, TX (US); Gerald D. Miller, Humble, TX (US)

Correspondence Address: M. Susan Spiering;c/o Celanese Ltd., IP Legal Dept., IZIP 701, P.O. Box 428, Bishop, TX, 78343, US

(21) Appl. No.: 10/731,495

(22) Filed: Dec. 9, 2003

(51) Int. Cl. C08K 3/00

(52) U.S. Cl. 524/557

(57) ABSTRACT

A method of preparing an optical brightener/PVOH aqueous concentrate comprising the sequential steps of: (a) providing an aqueous brightener composition including water and optical brightener active ingredient, wherein the optical brightener active ingredient is typically present in the aqueous brightener composition in an amount of from about 10% to about 25%; (b) admixing a polyvinyl alcohol resin with said aqueous optical brightener composition in an amount of about 1 part of dry polyvinyl alcohol resin per 0.5 to 10 wet parts of aqueous brightener composition to provide a nascent aqueous concentrate of polyvinyl alcohol resin and optical brightener; and (c) cooking the aqueous concentrate to dissolve the solids typically at a temperature of from about 175° F. to about 210° F. for a time of from about 10 minutes to about 120 minutes to provide a cooked brightener/polyvinyl alcohol concentrate.

This present invention relates to a novel methodology for preparing mixtures of polyvinyl alcohol (PVOH) and optical brighteners having high solids for easier drying and faster production rates.

### BACKGROUND OF THE INVENTION

Paper coating compositions, or coating colors, are used by the paper industry to impart the desired moisture resistance, physical properties and appearance to certain grades of finished paper. Generally, the coating composition is an aqueous dispersion consisting mainly of mineral pigments like clay, calcium carbonate or titanium dioxide, and pigment binders of natural protein, starch or synthetic polymer emulsions. Styrene-butadienes and polyvinyl acetates are examples of such synthetic emulsion binders. Coating compositions may also contain additives, such as thickeners, humectants and lubricants.

Coating compositions are usually applied to a continuous web of material by high speed coating machines, such as blade coaters, air knife coaters, rod coaters and roll coaters. It is advantageous to use faster coaters to increase productivity and to use higher solids coating compositions to decrease drying costs and improve binder distribution.

High brightness coated grades of paper typically include optical brighteners (OBs). Optical brighteners generally operate by way of absorbing ultra-violet radiation and then immediately re-admitting in the visible blue-white range. Examples of optical brighteners include UVITEX® and TINOPAL® from Ciba Specialty Chemicals, BLANKOPHOR® from Bayer and HOSTALUX® and LEUCOPHOR® from Clariant. Most Obs have active ingredients that belong to the stilbene class of compounds as shown in FIGS. 1, 2 and 3:

[image]

where M can be H, an alkali metal, ammonium or magnesium and R₁ represents hydrogen, C₁-C₅ alkyl, C₁-C₅ alkoxy or halogen.

Such compounds also include those of FIG. 2, further described herein.

[image]

U.S. Pat. No. 5,830,241 to Ciba Specialty Chemicals, Nov. 3, 1998, describes a liquid preparation of a fluorescent whitening agent, low MW polyethylene glycol, water and auxiliary compounds. The polyethylene glycol is in liquid form and functions as the non-volatile solvent to stabilize liquid preparations of the agent when stored at elevated temperatures (50° C.). The low MW of the polyethylene glycol has a low viscosity, which results in a pumpable solution. A typical structure of the fluorescent whitening agent is:

[image]

where M is H, an alkali metal, ammonium or magnesium and polyvinyl alcohol (PVOH) is a preferred carrier.

While OBs alone work well, the inclusion of PVOH boosts their performance. In some cases, paper makers use standard PVOH grades purchased in dry form which are then prepared for use by cooking in conventional batch vessels. A disadvantage of this methodology is that the water used in the PVOH cook dilutes the coating formulation by a significant amount, which can negatively impact production rates. In addition, there is a cost to the mill for cooking PVOH; and, in many cases, that cost is compounded with problems because of inadequate equipment or poorly trained operators. Generally, PVOH is supplied to papermakers in a variety of forms: 1) dry resin that is cooked in water by the customer at 20% to 30% solids, the advantage being that less costly grades of PVOH can be used, the drawbacks being noted above; 2) PVOH that has been pre-cooked and delivered to the customer at 15% to 25% solids, which is costly to the papermaker as it involves shipping mostly water; and 3) dry, fine particle size partially hydrolyzed grades that are added dry to the pigmented formulations. These latter products are relatively expensive ground material, but are convenient if cooking is not an option. See U.S. Pat. No. 5,057,570. See also U.S. Pat. No. 6,620,294 where there are described solutions of PVOH and optical brighteners prepared by thoroughly mixing the moist press cake or the dry powder of a fluorescent whitening agent with an aqueous solution of PVOH and heating.

It has been found in accordance with the present invention that relatively inexpensive grades of dry PVOH can be directly incorporated into an aqueous brightener composition, followed by cooking the mixture to solubilize the resin; providing product and manufacturing options not previously possible. In still other embodiments, relatively low viscosity PVOH resins are used.

### SUMMARY OF THE INVENTION

There is provided in accordance with the present invention a method of preparing an optical brightener/PVOH aqueous concentrate by way of the sequential steps of: (a) providing an aqueous brightener composition including water and optical brightener active ingredient, wherein the optical brightener active ingredient is present in the aqueous brightener composition typically in an amount of from about 10% to about 25%; (b) admixing a polyvinyl alcohol resin with said aqueous optical brightener composition in an amount of about 1 part of dry polyvinyl alcohol resin per 0.25 to 10 wet parts of aqueous brightener composition to provide a nascent aqueous concentrate of polyvinyl alcohol resin and optical brightener; and (c) cooking the aqueous concentrate to dissolve substantially all of the PVOH resin, usually at a temperature of from about 175° F. to about 210° F. generally for a time of from about 10 minutes to about 120 minutes to provide a cooked brightener/polyvinyl alcohol concentrate consisting essentially of water, polyvinyl alcohol resin and optical brightener active ingredient. Typically, the polyvinyl alcohol resin is admixed in an amount of about 1 part of dry polyvinyl alcohol resin per 0.5 to 10 wet parts of aqueous brightener composition.

The optical brightener active ingredient is usually present in the aqueous brightener composition in an amount of from about 12% to about 20% and the optical brightener/PVOH aqueous concentrate typically has a solids content of from about 20% to about 75% based on the water, polyvinyl alcohol and optical brightener active ingredient content of the concentrate. More typically, the polyvinyl alcohol is admixed with the aqueous optical brightener composition in an amount of from about 15% to about 55% PVOH based on the combined weight of the water, the optical brightener active ingredient and polyvinyl alcohol resin, the concentrate having a solids content of from about 30 to about 60%. Likewise, the aqueous concentrate is usually cooked to dissolve the solids at a temperature of from about 185° F. to about 205° F. for a time of from about 20 minutes to about 60 minutes. Suitable polyvinyl alcohol resins have viscosities of from about 2 or 3 cps to about 30 or 40 cps; most preferably in some cases the polyvinyl alcohol resin has a viscosity of from about 2 or 3 cps to about 7 or 8 cps or from about 3 cps to about 4 cps.

The polyvinyl alcohol resin is generally hydrolyzed on a mole percent basis of from about 80 to about 99.5 percent; typically, the polyvinyl alcohol resin is hydrolyzed on a mole percent basis of from about 85 percent to about 90 percent and has a degree of polymerization of from about 50 to about 2000. A degree of polymerization of from about 50 to about 1700 is more preferred as is a degree of polymerization of from about 50 to about 300.

Most preferably, the polyvinyl alcohol resin is added to the aqueous brightener composition in substantially dry form; and sometimes the step of diluting the aqueous concentrate is expedient, depending on processing characteristics sought. So also, the concentrate can be directly applied to a paper substrate in a size press, if so desired.

The method may further include the step of adding polyethylene glycol to the aqueous concentrate and wherein the polyethylene glycol is added to the aqueous brightener composition or to the nascent or cooked aqueous concentrate in an amount of from about 0.5 to about 2 parts by weight per dry part of polyvinyl alcohol resin.

A preferred method of preparing a color coat composition includes the sequential steps of:
(a) providing an aqueous brightener composition consisting essentially of water and optical brightener active ingredient, wherein the optical brightener active ingredient is present in the aqueous brightener composition in an amount of from about 10 to about 25%;
(b) admixing a polyvinyl alcohol resin with said aqueous optical brightener composition in an amount of about 1 part of dry polyvinyl alcohol resin per 0.25 to 10 wet parts of aqueous brightener composition to provide a nascent aqueous concentrate of polyvinyl alcohol resin and optical brightener;
(c) cooking the aqueous concentrate to dissolve the solids at a temperature of from about 175° F. to about 210° F. for a time of from about 10 minutes to about 120 minutes to provide a cooked brightener/polyvinyl alcohol concentrate consisting essentially of water, polyvinyl alcohol resin and optical brightener compounds; and
(d) admixing the cooked concentrate with an aqueous dispersion comprising color pigment and a binder resin to produce the color coat composition. Typically, the polyvinyl alcohol resin is admixed in an amount of about 1 part of dry polyvinyl alcohol resin per 0.5 to 10 wet parts of aqueous brightener composition.

The method further comprises the step of applying the color coat to paper.

An optical brightener aqueous concentrate consists essentially of water, an optical brightener active ingredient and a polyvinyl alcohol resin having a viscosity of from about 2 cps to about 4 cps, wherein the aqueous concentrate is from about 20 to about 75% solids, and the polyvinyl alcohol resin is hydrolyzed from about 80 to about 90 percent on a molar basis. The concentrate optionally includes auxiliaries such as dispersing agents, protective colloids, solvents for the colloids, and/or antifreezes, sequestering agents and the like, none of which change the basic and novel characteristics of the concentrates. When referring to the optical brightener/PVOH aqueous concentrate, auxiliaries also include minor amounts of binder, plasticizer, filler, water retention aids such as carboxymethyl cellulose and so forth. Typically, the polyvinyl alcohol resin has a viscosity of from 3 cps to 4 cps and the aqueous concentrate is from about 25 to about 65 percent solids. The optical brightener concentrate further comprises polyethylene glycol in some cases and the optical brightener active ingredient comprises a stilbene compound. The stilbene compound may be a sulfonated stilbene compound may be a stilbene compound of the formula:

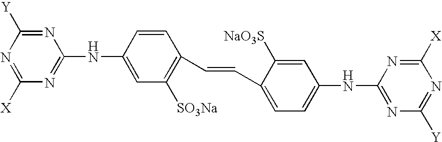

wherein X and Y are independently selected from the moieties in the following table.

| | Disulfo | Tetrasulfo 1 | Tetrasulfo 2 | Hexasulfo |
|---|---|---|---|---|
| X | 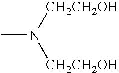 | 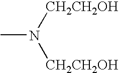 | 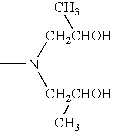 | 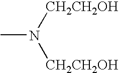 |
| Y | 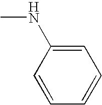 | 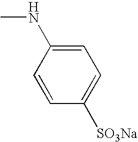 | 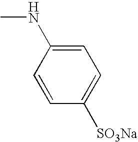 | 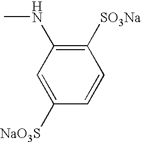 |

Thus, the brightener active ingredient may be disulfonated, tetrasulfonated or hexasulfonated in various embodiments.

In still yet another aspect of the invention, an optical brightener aqueous concentrate consists essentially of water, an optical brightener active ingredient, polyethylene glycol and a polyvinyl alcohol resin has a viscosity of from about 2 cps to about 4 cps, wherein the aqueous concentrate is from about 20 to about 75% solids, and wherein the polyvinyl alcohol resin is hydrolyzed from about 80 to about 90 percent on a molar basis.

### DETAILED DESCRIPTION OF THE INVENTION

The invention is described in detail below with reference to various examples for purposes of illustration, only. Modification to particular embodiments within the sprit and scope of the invention, set forth in appended claims, will be readily apparent to those of skill in the art.

As used herein, terminology has its ordinary meaning unless a more specific or more general meaning is given below or is clear from the context.

%, percent or per cent means weight percent unless mole percent is specified.

“Cps” means centipoise.

“Minor amount” means less than 50% by weight exclusive of water content.

PVOH means polyvinyl alcohol resins which are typically prepared from polyvinyl acetate resins by saponification thereof which is well known in the art. PVOH resins are derived from homopolymers of vinyl acetate as well as copolymers of vinyl acetate with other ethylenically unsaturated monomers and may include cationic sites if so desired. Preferably, the resins are 95 mole percent or more vinyl acetate derived. Suitable resins, available from Celanese, Inc. include:

TABLE 1
Polyvinyl Alcohol Resins

| Grade | % Hydrolysis, | Viscosity, cps¹ | pH |
|---|---|---|---|
| Celvol 125 | 99.3+ | 28-32 | 5.5-7.5 |
| Celvol 165 | 99.3+ | 62-72 | 5.5-7.5 |
| Fully | | | |
| Hydrolyzed | | | |
| Celvol 103 | 98.0-98.8 | 3.5-4.5 | 5.0-7.0 |
| Celvol 305 | 98.0-98.8 | 4.5-5.5 | 5.0-7.0 |
| Celvol 107 | 98.0-98.8 | 5.5-6.6 | 5.0-7.0 |
| Celvol 310 | 98.0-98.8 | 9.0-11.0 | 5.0-7.0 |
| Celvol 325 | 98.0-98.8 | 28.0-32.0 | 5.0-7.0 |
| Celvol 350 | 98.0-98.8 | 62-72 | 5.0-7.0 |
| Intermediate | | | |
| Hydrolyzed | | | |
| Celvol 418 | 91.0-93.0 | 14.5-19.5 | 4.5-7.0 |
| Celvol 425 | 95.5-96.5 | 27-31 | 4.5-6.5 |
| Partially | | | |
| Hydrolyzed | | | |
| Celvol 502 | 87.0-89.0 | 3.0-3.7 | 4.5-6.5 |
| Celvol 203 | 87.0-89.0 | 3.5-4.5 | 4.5-6.5 |
| Celvol 205 | 87.0-89.0 | 5.2-6.2 | 4.5-6.5 |
| Celvol 513 | 86.0-89.0 | 13-15 | 4.5-6.5 |
| Celvol 523 | 87.0-89.0 | 23-27 | 4.0-6.0 |
| Celvol 540 | 87.0-89.0 | 45-55 | 4.0-6.0 |

¹4% aqueous solution, 20° C.

When the viscosity of a polyvinyl alcohol resin is specified, the viscosity is the viscosity of a 4% aqueous (wt/wt) solution of the PVOH, at 20° C.

Suitably, CIE L*, a*, b* and brightness values are used to characterize coated products 10 prepared with coating formulations of the invention. L*, a*, and b* values may be suitably measured using test methods such as TAPPI T 524 om-02, TAPPI T 527 om-02, or similar methods. TAPPI T 524 incorporates 45° directional illumination and perpendicular (0°). observation geometry. TAPPI T 527 incorporates diffuse illumination and 0° observation geometry. L* is a measure of lightness increasing from 0 for black to 100 for perfect white; a* 15 indicates redness when positive and green when negative; b* indicates yellowness when positive and blueness when negative. Note that (GE) brightness is measured in accordance with TAPPI T 452 om-02. TAPPI 452 incorporates 45° illumination and 0° observation geometry.

The aqueous pigment dispersion with which the inventive concentrates are combined typically consists of clay or calcium carbonate or mixtures of the two at solids levels ranging from about 70 to 76%. In general, at least a portion of the pigment comprises calcium carbonate and for the clay portion, any of the clays customarily used for the paper coating, such as the hydrous aluminum silicates of the kaolin group clays, hydrated silica clays and the like can be used. In addition to the calcium carbonate and clay, there may be added other paper pigments, such as, for example titanium dioxide, blanc fixe, lithopone, zinc sulfide, or other coating pigments, including plastics, for example, polystyrene, in various ratios, for example, up to 50 wt. %., preferably up to 35 wt. % based on calcium carbonate and clay. Additionally, the composition may also contain other additives, such as zinc oxide and/or a small amount of a dispersing or stabilizing agent, such as tetra-sodium pyrophosphate.

Suitable low molecular weight, partially or mostly hydrolyzed polyvinyl alcohols for the practice of this invention can be 70-99.5%, preferably 85-90, and most preferably 87-89, mole % hydrolyzed and have a degree of polymerization (DP) ranging from 50-600, preferably 185 to 255. Another means for assessing the DP of the polyvinyl alcohol is its viscosity as a 4 wt. % aqueous solution at 20° C. Suitable polyvinyl alcohols have a viscosity ranging from about 2 to 30 cps, preferably 3-4 cp. Such polyvinyl alcohols can be prepared by synthesis and saponification techniques well known to those skilled in the art of manufacturing polyvinyl alcohol. A preferred polyvinyl alcohol having a viscosity of about 4 cp and an 87-89 mole % hydrolysis is marketed by Celanese under the trademark CELVOL® C-203. Another preferred polyvinyl alcohol is CELVOL® C-502, which has a viscosity of about 3 cp. The polyvinyl alcohol is incorporated as a dry powder into the aqueous OB solution. The optical brightener active ingredients are of the stilbene class noted above and have the general structure of FIG. 1 or FIG. 2 or FIG. 3. These compounds are typically obtained as aqueous solutions of 15-20% solids or so. Suitable stilbenes are disclosed in U.S. Pat. No. 6,620,294 and U.S. Pat. No. 5,830,241, the disclosures of which are incorporated by reference. Commercially available optical brighteners include UVITEX® and TINOPAL® from Ciba Specialty Chemicals, BLANKOPHOR® from Bayer and HOSTALUX® and LEUCOPHOR® from Clariant.

The high solids aqueous pigment dispersion containing the polyvinyl alcohol as a co-binder can then be used to prepare paper coating compositions comprising (parts by wt): 100 parts pigment containing clay and/or calcium carbonate and 0 to 35 parts secondary pigment; 0.01 to 0.5 parts dispersing or stabilizing agent; 1 to 30 parts polymer binder emulsion (solids basis); 0.1 to 10 parts, preferably 0.5 to 2 parts, polyvinyl alcohol co-binder; 0.1 to 20 parts other co-binders; 0 to 0.2 parts defoamer, and sufficient water to provide the desired level of solids, usually about 45 to 70 wt. %, preferably 60 to 70 wt. % or more for high solids paper coating compositions.

The coating compositions produced may be applied to fibrous paper webs using any of the conventional coating devices, including trailing blade coaters, air-knife coaters roll coaters, and the like.

It is possible to cook the PVOH in the presence of OB as delivered at ˜17% solids without the addition of water as hereinafter described.

The appearance of the resulting cooked blend, other than viscosity, does not change.

Because of the viscosity, sometimes dilutions are desirable. However, at 27% blends solids, the papermaker has the benefit of a relatively high solids solution.

Experimental

For all the formulations discussed below, pigments are primarily calcium carbonate and clay, but may include titanium dioxide. There are optionally other ingredients such as carboxymethyl cellulose, lubricants, dyes, defoamers, as is well known in the art. Units are expressed as dry pts/100 pigment, except for the OB. In terms of raw materials, pigments are delivered in dry or in water pre-dispersed form that may range from about 70% to 76% solids. Styrene butadiene latexes are delivered at about 50% solids. PVOH may be delivered in solid form to be cooked into solution prior to using, or in liquid form at 15% to 30% solids. OBs for coating are delivered in liquid form at about 17% active ingredient, and are most preferably of the tetra or hexa sulfonated variety.

Blends and coatings described below include 1/1, 2/1, 3.75/1 and 5/1 wet OB (Ciba's TINOPAL® PT, a tetrasulfonated form)/dry PVOH (CELVOL® 203).

Normal operations in paper mills call for PVOH and OBs to be added each as liquids into the formulating tank. However, the invention takes advantage of the water in the OB through the addition of dry PVOH to 100 pts of OB slurry in a vessel while stirring sufficiently to disperse the PVOH particles in a uniform fashion. The contents are then heated to 185° F. to 205° F., depending upon the grade of PVOH used, preferably by steam heated water bath. The temperature of the blend is held at temperature for 30 minutes, at which time the PVOH will be totally solubilized and the blend may be either cooled or used hot. The solids levels above are considered maximum since no dilutions have taken place.

As shown below, in the various Examples, the method of this invention results in paper coating formulations with higher total coating solids than can be achieved by conventional methods. Using current methodology, for the ratios of OB/PVOH indicated and utilizing standard pigment dispersions of either 70% or 76% solids, the maximum coating solids that can be achieved, by adding the OB and PVOH (25% solids) each as liquids, range from 64.4% to 70.0% and 69.0% to 70.2% (using 30% solids PVOH).

In contrast, the method of this invention adds dry PVOH to an OB solution. After the dry PVOH is added, the formulation is heated for 30 minutes at temperatures ranging from 185° F. to about 205° F. to completely solubilize the PVOH. This solution is then added to either a 70% or 76% solids pigment dispersion to achieve the final coating solids shown below.

Color coat formulations are sometimes expressed in dry parts and wet parts per 100 parts dry pigment. A typical or “standard” coating formulation is as follows:
100 parts dry pigment@70% solids=142.9 wet parts
14 dry parts latex@50% solids=28 wet parts
0.34 dry parts@17% Active Ingredient=2 wet parts
1 dry part PVOH@25% solids=4 wet parts

Table 2 below shows solids content for a standard formulation with 2/1 wet parts/dry parts OB/PVOH ratio per 100 parts of pigment by way of conventional formulation techniques.

TABLE 2
Sample Calculation

| Dry Parts | Ingredient | Wet parts |
|---|---|---|
| 100 | Pigment at 70% solids | 142.9 |
| 14 | Latex at 50% solids | 28.0 |
| 0.34 | OB at 17% solids | 2.0 |
| 1.0 | PVOH at 25% solids | 4 |
| 115.34 | TOTALS | 176.9 |
| | Solids Percentage = | |
| | 65.2% | |

With the invention, carrier water from the PVOH resin composition is eliminated and the same “dry” formulation (2/1 wet OB/dry PVOH) has the composition shown in Table 3, with a solids advantage of 1.1% overall.

TABLE 3
Sample Calculation

| Dry Parts | Ingredient | Wet parts |
|---|---|---|
| 100 | Pigment at 70% solids | 142.9 |
| 14 | Latex at 50% solids | 28.0 |
| 1.34 | OB/PVOH at 44.7% solids* | 2.99 |
| 115.34 | TOTALS | 173.89 |
| | Percentage = 66.3% | |

*The foregoing uses the 44.7% solids solution shown in Example Series 2 with the 70% pigment dispersion.

Following are numerous additional examples and comparative examples showing the solids advantages realized with the invention as opposed to conventional formulation techniques. These examples use the standard components specified above, varying wet OB/dry PVOH ratios and pigment solids content.

1/1 Wet OB/Dry PVOH

### COMPARATIVE EXAMPLE SERIES A

The color coat is formulated with either 70% or 76% solids pigment dispersions and 25% or 30% PVOH solution. Using the standard methodology of mixing liquid OB (usually 17% solids) with liquid PVOH, and adding to the pigment dispersion, the solids that can be achieved is shown below in Table 4:

TABLE 4
1/1 Wet OB/Dry PVOH

| | Current Methodology |
|---|---|
| % Solids | Ingredients Added Separately |
| Pigment | Coating Solids, % |
| 70% | 65.5% using 25% solids PVOH |
| 76% | 70.0% using 25% solids PVOH |
| 76% | 70.2% using 30% solids PVOH |

### EXAMPLE SERIES 1

In contrast to the above, the invention utilizes a solution prepared by adding dry PVOH to a 17% solution of OB to achieve the following concentrations. In this case, the OB/PVOH solution is prepared as follows:
83 pts water and 17 pts active ingredient OB+100 pts dry PVOH. Dry solids=(100+17)/200=58.5%; cooked as noted above.

This solution is subsequently added to the pigment dispersion to achieve the results shown in Table 5:

TABLE 5
1/1 Wet OB/Dry PVOH
Invention Pre-Blend
One Addition Process
No Dilution of Blend

| % Solids | Coating | % Solids |
|---|---|---|
| Pigment | % Solids | Advantage |
| 70 | 66.6 | +1.1 |
| 76 | 71.2 | +1.2 |
| 76 | 71.2 | +1.0 |

As can be seen from the above table, there is a distinct solids advantage over current practice.
2/1 Wet OB/Dry PVOH

### COMPARATIVE EXAMPLE SERIES B

Following the procedures outlined above, the maximum solids attainable using conventional procedures is shown in Table 6:

TABLE 6
2/1 Wet OB/Dry PVOH

| | Current Methodology |
|---|---|
| % Solids | Ingredients Added Separately |
| Pigment | Coating Solids, % |
| 70% | 65.2% using 25% solids PVOH |
| 76% | 69.6% using 25% solids PVOH |
| 76% | 69.9% using 30% solids PVOH |

### EXAMPLE SERIES 2

Dry PVOH is mixed with 17% OB according to the following formula:
83 pts water and 17 pts active ingredient OB+50 pts dry PVOH. Dry solids=(50+17)/150=5 44.7%; followed by cooking.

This is added to the pigment dispersion to achieve the results and solids advantage shown in Table 7:

TABLE 7
2/1 Wet OB/Dry PVOH
Invention Pre-Blend
One Addition Process
No Dilution of Blend

| % Solids | Coating | % Solids |
|---|---|---|
| Pigment | % Solids | Advantage |
| 70 | 66.3 | +1.1 |
| 76 | 70.9 | +1.3 |
| 76 | 70.9 | +1.0 |

3.75 Wet OB/Dry PVOH

### COMPARATIVE EXAMPLE SERIES C

Following the above, the following maximum solids are achieved:

TABLE 8
3.75/1 Wet OB/Dry PVOH

| | Current Methodology |
|---|---|
| % Solids | Ingredients Added Separately |
| Pigment | Max Coating Solids Possible, % |
| 70% | 64.7% using 25% solids PVOH |
| 76% | 69.1% using 25% solids PVOH |
| 76% | 69.4% using 30% solids PVOH |

### EXAMPLE SERIES 3

PVOH/OB mixture follows the formula below:
83 pts water and 17 pts active ingredient OB+26.7 pts dry PVOH. Dry solids=(26.7+17)/126.7=34.5; followed by cooking.

The results are shown in Table 9:

TABLE 9
3.75/1 Wet OB/Dry PVOH
Invention Pre-Blend
One Addition Process
No Dilution of Blend

| % Solids | Coating | % Solids |
|---|---|---|
| Pigment | % Solids | Advantage |
| 70 | 65.8 | +1.1 |
| 76 | 70.4 | +1.3 |
| 76 | 70.4 | +1.0 |

5/1 Wet OB/Dry PVOH

### COMPARATIVE EXAMPLE SERIES D

Similarly, current practice yields the following maximum % solids:

TABLE 10
5/1 Wet OB/Dry PVOH

| | Current Methodology |
|---|---|
| % Solids | Ingredients Added Separately |
| Pigment | Coating Solids, % |
| 70% | 64.4% using 25% solids PVOH |
| 76% | 68.7% using 24% solids PVOH |
| 76% | 69.0% using 30% solids PVOH |

### EXAMPLE SERIES 4

The OB/PVOH solution is prepared as follows:
83 pts water and 17 pts active ingredient OB+20 pts dry PVOH. Dry solids=(20+17)/120=30.8%; followed by cooking.

The results are shown in Table 11:

TABLE 11
5/1 Wet OB/Dry PVOH
Invention Pre-Blend
One Addition Process
No Dilution of Blend

| % Solids | Coating | % Solids |
|---|---|---|
| Pigment | % Solids | Advantage |
| 30.8 | 65.5 | +1.1 |
| 30.8 | 70.0 | +1.3 |
| 30.8 | 70.0 | +1.0 |

The results for the above Examples are summarized in Table 12 below:

TABLE 12

| Ratio | | | Invention Pre-Blend | | |
|---|---|---|---|---|---|
| OB/PVOH | | | One Addition Process | | |
| Wet pts/Dry | | Current Methodology | No Dilution of Blend | | |
| Pts | | Ingredients Added | | | Coating % |
| per 100 pts | % Solids | Separately | | Coating % | Solids |
| Pigment | Pigment | Coating Solids, % | % Solids | Solids | Advantage |
| 1/1 | 70% | 65.5% using 25% solids | 58.5 | 66.6 | +1.1 |
| | | PVOH | | | |
| 2/1 | | 65.2% using 25% solids | 44.7 | 66.3 | +1.1 |
| | | PVOH | | | |
| 3.75/1 | | 64.7% using 25% solids | 34.4 | 65.8 | +1.1 |
| | | PVOH | | | |
| 5/1 | | 64.4% using 25% solids | 30.8 | 65.5 | +1.1 |
| | | PVOH | | | |
| 1/1 | 76% | 70.0% using 25% solids | 58.5 | 71.2 | +1.2 |
| | | PVOH | | | |
| 2/1 | | 69.6% using 25% solids | 44.7 | 70.9 | +1.3 |
| | | PVOH | | | |
| 3.75/1 | | 69.1% using 25% solids | 34.4 | 70.4 | +1.3 |
| | | PVOH | | | |
| 5/1 | | 68.7% using 24% solids | 30.8 | 70.0 | +1.3 |
| | | PVOH | | | |
| 1/1 | 76% | 70.2% using 30% solids | 58.5 | 71.2 | +1.0 |
| | | PVOH | | | |
| 2/1 | | 69.9% using 30% solids | 44.7 | 70.9 | +1.0 |
| | | PVOH | | | |
| 3.75/1 | | 69.4% using 30% solids | 34.4 | 70.4 | +1.0 |
| | | PVOH | | | |
| 5/1 | | 69.0% using 30% solids | 30.8 | 70.0 | +1.0 |
| | | PVOH | | | |

### EXAMPLE SERIES 5

The above formulations of this invention represent no dilutions in the blend. Viscosities at the 3.75/1 ratio were ˜10,000 cps and at 2/1 greater than 73,000 cps, because of increasing solids. Blends at the 5/1 ratio were ˜4,000-5,000 cps initially through 3 days at 30.8% solids.

It is desirable in some cases to achieve a standard target of 27% total solids by dilution of the inventive formulations. At this level, the viscosity of all of the PVOH/OB concentrates ranged from 2,000-4,000 cps and there was still exhibited a solids advantage over conventional practice, as shown in Table 13 below.

TABLE 13

| Ratio | | | | |
|---|---|---|---|---|
| OB/PVOH | Current Methodology | Invention Pre-Blend* | | |
| Wet pts/Dry | Ingredients Added | | | % |
| Pts | Separately | | Coat- | Solids |
| per 100 pts | Max Coating Solids | Viscosity, | ing % | Advan- |
| Pigment | Possible, % | cps | Solids | tage |
| 1/1 | 65.5% using 25% solids | 2000-4000 | 65.7 | +0.2 |
| | PVOH | | | |
| 2/1 | 65.2% using 25% solids | 2000-4000 | 65.5 | +0.3 |
| | PVOH | | | |
| 3.75/1 | 64.7% using 25% solids | 2000-4000 | 65.3 | +0.6 |
| | PVOH | | | |
| 5/1 | 64.4% using 25% solids | 2000-4000 | 65.2 | +0.8 |
| | PVOH | | | |
| 1/1 | 70.0% using 25% solids | 2000-4000 | 70.2 | +0.2 |
| | PVOH | | | |
| 2/1 | 69.6% using 25% solids | 2000-4000 | 70.0 | +0.4 |
| | PVOH | | | |
| 3.75/1 | 69.1% using 25% solids | 2000-4000 | 69.8 | +0.7 |
| | PVOH | | | |
| 5/1 | 68.7% using 24% solids | 2000-4000 | 69.6 | +0.9 |
| | PVOH | | | |
| 1/1 | 70.2% using 30% solids | 2000-4000 | 70.2 | 0.0 |
| | PVOH | | | |
| 2/1 | 69.9% using 30% solids | 2000-4000 | 70.0 | +0.1 |
| | PVOH | | | |
| 3.75/1 | 69.4% using 30% solids | 2000-4000 | 69.8 | +0.4 |
| | PVOH | | | |
| 5/1 | 69.0% using 30% solids | 2000-4000 | 69.6 | +0.6 |
| | PVOH | | | |

*All formulations diluted to 27% solids

### EXAMPLES 6-10 COMPARATIVE EXAMPLE SERIES E

These examples show that the novel process of this invention does not impair the performance of the optical brightener. The formulation for the paper coatings was as follows:
75/25 dry parts CaCO₃/No. 1 Clay Pigment
14 dry parts styrene-butadiene latex binder
0.3 dry parts carboxymethylcellulose water retention aid
x wet parts OB (TINOPAL® PT)
y dry parts PVOH (CELVOL 203 or 502)
Solids ˜62%

The formulations were then coated onto paper using a cylindrical coater. Brightness testing results appear in Table 14 below.

The control is the basic liquid-liquid addition sequence of PVOH and OB, whereas Examples 6-10 are in-situ pre-cooked PVOH/OB blends as noted above. Example 6 and the control are both formulated with a 3.75/1 wet OB/dry PVOH. The base paper has a brightness of 84.3 (standard—no UV). After coating, brightness values of the paper (again—no UV) improve to 85.3 and 85.6. The UV brightness measurements show a very significant further improvement to 89.0 and 88.9—comparable to each other. The a* value indicates color shading to either red or green and these would be considered equal to each other. The b* value is important because it indicates the desirable blue-white with negative values and undesirable yellow with positive values. The negative values are desirable and not significant in their differences.

Examples 7 and 8 are formulated at 2/1 with OB/dry PVOH and compare the performance of two PVOH samples with different viscosity values. Both are pre-cooked with OB as per the invention. The significance here is that C-502 performs as well as C-203 and, since it is lower in viscosity, will allow for higher blend solids from 27% to 30% in the optical brightener concentrate for higher coating color solids benefits.

Following the same procedures, Examples 9 and 10 were formulated at 2/1/1 wet OB/dry PVOH/polyethylene glycol 400; except that Example 10 had 2 parts less SBR.

TABLE 14

| | Invention | | Brightness Testing | | | | | |
|---|---|---|---|---|---|---|---|---|
| | 27% Solids | Coat | Base | Coated | Coated | | | |
| | Wet OB/dry | Wt. Lbs/ | Paper | Paper | Paper | UV | | |
| Formulation | PVOH | 3300 ft² | No UV | No UV | With UV | Component | a* | b* |
| Base | | | 84.3 | | | | | |
| Comp. | | 7.7 | | 85.3 | 89.0 | +3.7 | +0.02 | −0.37 |
| Ex. E¹ | | | | | | | | |
| EX 6 | 3.75/1 | 7.3 | | 85.6 | 88.9 | +3.3 | −0.03 | −0.45 |
| | (C-203) | | | | | | | |
| EX 7 | 2/1(C-203) | 7.8 | | 85.4 | 89.6 | +4.2 | +0.41 | −0.98 |
| EX 8 | 2/1 (C-502) | 7.4 | | 85.9 | 89.6 | +3.7 | +0.37 | −1.10 |
| EX 9 | 2/1/1 (C-203) | 7.4 | | 85.7 | 89.7 | +4 | +0.50 | −1.28 |
| | (PEG 400) | | | | | | | |
| EX 10 | 2/1/1 (−2 | 7.4 | | 86.2 | 90 | +3.9 | +0.48 | −1.27 |
| | parts SBR) | | | | | | | |

¹3.75/1 OB wet pts/25% C-203 dry pts by separate additions

1. A method of preparing an optical brightener/PVOH aqueous concentrate comprising the sequential steps of:
a) providing an aqueous brightener composition including water and optical brightener active ingredient;
b) admixing a polyvinyl alcohol resin with said aqueous optical brightener composition in an amount of about 1 part of dry polyvinyl alcohol resin per 0.25 to 10 wet parts of aqueous brightener composition to provide a nascent aqueous concentrate of polyvinyl alcohol resin and optical brightener; and
c) cooking the aqueous concentrate to dissolve the solids at an elevated temperature for a time sufficient to dissolve substantially all of the polyvinyl alcohol resin so as to provide a cooked brightener/polyvinyl alcohol concentrate including water, polyvinyl alcohol resin, optical brightener, and optionally minor amounts of auxiliaries.

2. The method according to claim 1, wherein the optical brightener active ingredient is present in the aqueous brightener composition in an amount of from about 10% to about 25%.

3. The method according to claim 1, wherein the optical brightener active ingredient is present in the aqueous brightener composition in an amount of from about 12% to about 20%.

4. The method according to claim 1, wherein the optical brightener/PVOH aqueous concentrate has a solids content of from about 20% to about 75% based on the water, polyvinyl alcohol and optical brightener active ingredient content of the concentrate.

5. The method according to claim 1, wherein said polyvinyl alcohol is admixed with said aqueous optical brightener composition in an amount of from about 15% to about 55% PVOH based on the combined weight of said water, said optical brightener active ingredient and said polyvinyl alcohol resin, the concentrate having a solids content of from about 30 to about 60%.

6. The method according to claim 1, wherein said aqueous concentrate is cooked to dissolve said solids at a temperature of from about 175° F. to about 210° F. for a time of from about 10 minutes to about 120 minutes.

7. The method according to claim 1, wherein said aqueous concentrate is cooked to dissolve said solids at a temperature of from about 185° F. to about 205° F. for a time of from about 20 minutes to about 60 minutes.

8. The method according to claim 1, wherein the polyvinyl alcohol resin has a viscosity of from about 2 cps to about 40 cps.

9. The method according to claim 1, wherein the polyvinyl alcohol resin has a viscosity of from about 2 cps to about 8 cps.

10. The method according to claim 1, wherein the polyvinyl alcohol resin has a viscosity of from about 3 cps to about 30 cps.

11. The method according to claim 1, wherein the polyvinyl alcohol resin has a viscosity of from about 3 cps to about 8 cps.

12. The method according to claim 1, wherein the polyvinyl alcohol resin has a viscosity of from about 3 cps to about 7 cps.

13. The method according to claim 1, wherein the polyvinyl alcohol resin is hydrolyzed on a mole percent basis of from about 80 to about 99.5 percent.

14. The method according to claim 1, wherein the polyvinyl alcohol resin is hydrolyzed on a mole percent basis of from about 85 percent to about 90 percent.

15. The method according to claim 1, wherein the polyvinyl alcohol resin has a degree of polymerization of from about 50 to about 2000.

16. The method according to claim 1, wherein the polyvinyl alcohol resin has a degree of polymerization of from about 50 to about 300.

17. The method according to claim 1, wherein the polyvinyl alcohol resin is added to the aqueous brightener composition in substantially dry form.

18. The method according to claim 1, further comprising the step of diluting the aqueous concentrate.

19. The method according to claim 1, further comprising the step of adding polyethylene glycol to said aqueous brightener composition or to said nascent or cooked aqueous concentrate.

20. The method according to claim 19, wherein said polyethylene glycol is added to said aqueous brightener composition or to said nascent or cooked aqueous concentrate in an amount of from about 0.5 to about 2 parts by weight per dry part of polyvinyl alcohol resin.

21. The method according to claim 1, wherein the optical brightener/PVOH concentrate includes a minor amount of at least one auxiliary selected from dispersing agents, productive colloids, solvents for the colloids, antifreeze, sequestering agents, binder, plasticizer, filler and water retention aids.

22. The method according to claim 1, further comprising the step of applying the optical brightener/PVOH concentrate directly to a paper substrate.

23. A method of preparing a color coat composition comprising the sequential steps of:
(a) providing an aqueous brightener composition including water and optical brightener active ingredient;
(b) admixing a polyvinyl alcohol resin with said aqueous optical brightener composition in an amount of about 1 part of dry polyvinyl alcohol resin per 0.5 to 10 wet parts of aqueous brightener composition to provide a nascent aqueous concentrate of polyvinyl alcohol resin and optical brightener;
(c) cooking the aqueous concentrate to dissolve the solids at an elevated temperature for a time sufficient to dissolve substantially all of the polyvinyl alcohol resin so as to provide a cooked brightener/polyvinyl alcohol concentrate of water, polyvinyl alcohol resin and optical brightener, and optionally minor amounts of auxiliaries; and
(d) admixing the cooked concentrate with an aqueous dispersion comprising color pigment and a binder resin to produce the color coat composition.

24. The method according to claim 23, further comprising the step of applying said color coat to paper.

25. The method according to claim 23, wherein the polyvinyl alcohol resin is added to the optical brightener composition in substantially dry form.

26. An optical brightener aqueous concentrate consisting essentially of water, an optical brightener active ingredient and a polyvinyl alcohol resin having a viscosity of from about 2 cps to about 4 cps, wherein the aqueous concentrate is from about 20 to about 75% solids, and wherein the polyvinyl alcohol resin is hydrolyzed from about 80 to about 90 percent on a molar basis.

27. The optical brightener concentrate according to claim 26, wherein the polyvinyl alcohol resin has a viscosity of from 3 cps to 4 cps.

28. The optical brightener concentrate according to claim 26, wherein the aqueous concentrate is from about 25 to about 65 percent solids.

29. The optical brightener concentrate according to claim 26, further comprising polyethylene glycol.

30. The optical brightener concentrate according to claim 26 wherein the optical brightener active ingredient comprises a stilbene compound.

31. The optical brightener concentrate according to claim 30, wherein the stilbene compound is a sulfonated stilbene compound.

32. The optical brightener concentrate according to claim 31, wherein the sulfonated stilbene compound is a tetrasulfonated stilbene compound.

33. The optical brightener concentrate according to claim 31, wherein the sulfonated stilbene compound is a hexasulfonated stilbene compound.

34. The optical brightener concentrate according to claim 26, wherein the optical brightener active ingredient comprises a stilbene compound of the formula: 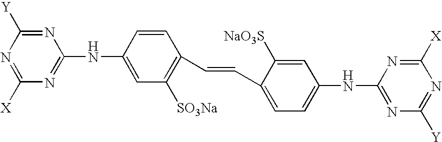
wherein X and Y are independently selected from the moieties indicated below:

| | Disulfo | Tetrasulfo 1 | Tetrasulfo 2 | Hexasulfo |
|---|---|---|---|---|
| X | 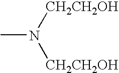 | 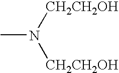 | 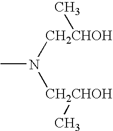 | 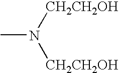 |
| Y | 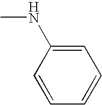 | 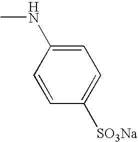 | 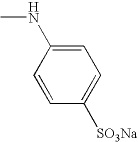 | 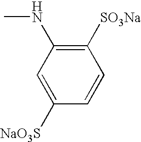 |

35. An optical brightener aqueous concentrate consisting essentially of water, an optical brightener active ingredient, polyethylene glycol and a polyvinyl alcohol resin having a viscosity of from about 3 cps to about 4 cps, wherein the aqueous concentrate is from about 20 to about 75% solids, and wherein the polyvinyl alcohol resin is hydrolyzed from about 80 to about 90 percent on a molar basis.
